(19) United States
(12) Patent Application Publication
(10) Pub. No.: US 2014/0188672 A1
(43) Pub. Date: Jul. 3, 2014

(54) SYSTEMS, METHODS AND INTERFACES FOR EVENT INVESTIGATION WITHIN AN ONLINE RESEARCH SYSTEM

(71) Applicants: SCOTT FRANCIS, Prior Lake, MN (US); David Hendricksen, Eagan, MN (US)

(72) Inventors: SCOTT FRANCIS, Prior Lake, MN (US); David Hendricksen, Eagan, MN (US)

(21) Appl. No.: 13/727,697

(22) Filed: Dec. 27, 2012

(51) Int. Cl. G06Q 50/18; G06Q 40/00

(52) U.S. Cl. CPC G06Q 50/18; G06Q 40/10
USPC 705/30

(57) ABSTRACT

A method including receiving an event investigation inquiry and retrieving a first set of research event information based on the event investigation inquiry and a second set of research event information based on the event investigation inquiry, the first set of research event information and the second set of research event information associated with a first research event and a second research event, respectively. The method further includes aggregating the first set of research event information and the second set of research event information into an aggregated set of research event information and providing a result in an interactive format that allows for one or more views, wherein the result is associated with the aggregated set of research event information and each view is associated with a different representation of the aggregated set of research event information.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records for non-commercial purposes, but otherwise reserves all copyrights whatsoever. The following notice applies to this document: Copyright© 2012 Thomson Reuters.

### TECHNICAL FIELD

Various embodiments of the present invention concern systems, methods and interfaces for event investigation within an online research system.

### BACKGROUND

Very few businesses have had to adjust to a more profoundly different marketplace than large law firms in recent years. Those firms that have good project management processes in place and good awareness of what they know, what they have done and how they did it are in a much better position to prosper. In addition, the self-awareness of these firms allows them to better understand their costs and thresholds. This understanding helps firms establish more predictable pricing that in turn delivers satisfactory client outcomes while producing a sound bottom line.

In today's marketplace, firms are not only expected to explain their billing to the client but they must also demonstrate significant and measurable business value, all while trying to satisfy their own need for growth. Law firms need better tools, and known cost recovery solutions are just not enough. In particular, law firm librarians need to drill deeper to investigate billing and analyze research which gets closer to user activity through details around searches performed and documents viewed. The term “law firm,” “firm” and all forms thereof are used synonymously herein. Such a window into research activity helps firms predict future costs, benefiting both the firm and its clients. With these demands, legal professionals must have information to help them predict their costs and determine, on a case by case basis, whether handling a given legal case is right for them.

Accordingly, the inventors have recognized the necessity for additional improvements in event investigation within an online research system.

### SUMMARY

The inventors propose an automated technique for investigating and analyzing events within an online research system. More specifically, they have invented systems and methods which, in response to an event investigation inquiry: 1) retrieve, from a content database, a first set of research event information and a second set of research event information associated with a first research event and a second research event, respectively; 2) aggregate the first set of research event information and the second set of research event information into an aggregated set of research event information; and 3) provide a result in an interactive format that allows for one or more views. The result is associated with the aggregated set of research event information. In addition, each view is associated with a different representation of the aggregated set of research event information.

One advantage of the present invention responds to the need for a modernized reporting environment that helps firms better understand their legal research trends and integrate those understandings flexibly into their evolving client billing strategies. One instance of the present invention has sophisticated analytics that provide a predictive environment to support effective client billing. This advantage provides opportunities for every firm to be more efficient and potentially recover more of its online legal research costs. In an example of the present invention, an administrator of a law firm can analyze the online research usage by user, practice area, office location and/or client number in order to effectively manage which research system charges are passed on to the client (also referred to herein as a billable charge) and which research system charges are retained (also referred to herein as a non-billable charge).

Another advantage of the present invention allows greater transparency into the firm's legal research usage than has been available before. The comprehensive information is analyzed and available in an interactive format to allow the firm to use predictability to determine the workload of future legal cases. This information is valuable for the firm as well as the clients. Now when a librarian or practice area lead is trying to better understand a research system charge, he/she navigates through the details of the research session in question, including queries performed, documents viewed and actions taken. By giving a more granular report of the data being used, law librarians, for instance, are able to hone in on the most beneficial training for future associates, see if associates are researching outside of the firm's subscriptions and find patterns in research that would otherwise go undiscovered. In another example, a practice area lead could look for trends in research management across multiple matters to help the firm better budget for projects or manage proposals.

Additional advantages and/or features of the present invention will be set forth in part in the description. It is to be understood that both the foregoing general description and the following detailed description of the present invention are exemplary and explanatory and are intended to provide further explanation of the present invention as claimed.

### BRIEF DESCRIPTION OF THE DRAWINGS

FIG. 1 is an exemplary system 100 which corresponds to one or more embodiments of the invention.

FIG. 2 is an exemplary method 200 which corresponds to one or more embodiments of the invention.

FIG. 3 is an exemplary interface 300 which corresponds to one or more embodiments of the invention.

FIG. 4 is an exemplary result 400 which corresponds to one or more embodiments of the invention.

FIG. 5 is an exemplary result 500 which corresponds to one or more embodiments of the invention.

FIG. 6 is an exemplary result 600 which corresponds to one or more embodiments of the invention.

FIG. 7 is an exemplary result 700 which corresponds to one or more embodiments of the invention.

FIG. 8 is an exemplary result 800 which corresponds to one or more embodiments of the invention.

FIG. 9 is an exemplary result 900 which corresponds to one or more embodiments of the invention.

FIG. 10 is an exemplary result 1000 which corresponds to one or more embodiments of the invention.

FIG. 11 is an exemplary result 1100 which corresponds to one or more embodiments of the invention.

FIG. 12 is an exemplary result 1200 which corresponds to one or more embodiments of the invention.

FIG. 13 is an exemplary interface 1300 which corresponds to one or more embodiments of the invention.

### DETAILED DESCRIPTION OF THE EXEMPLARY EMBODIMENT(S)

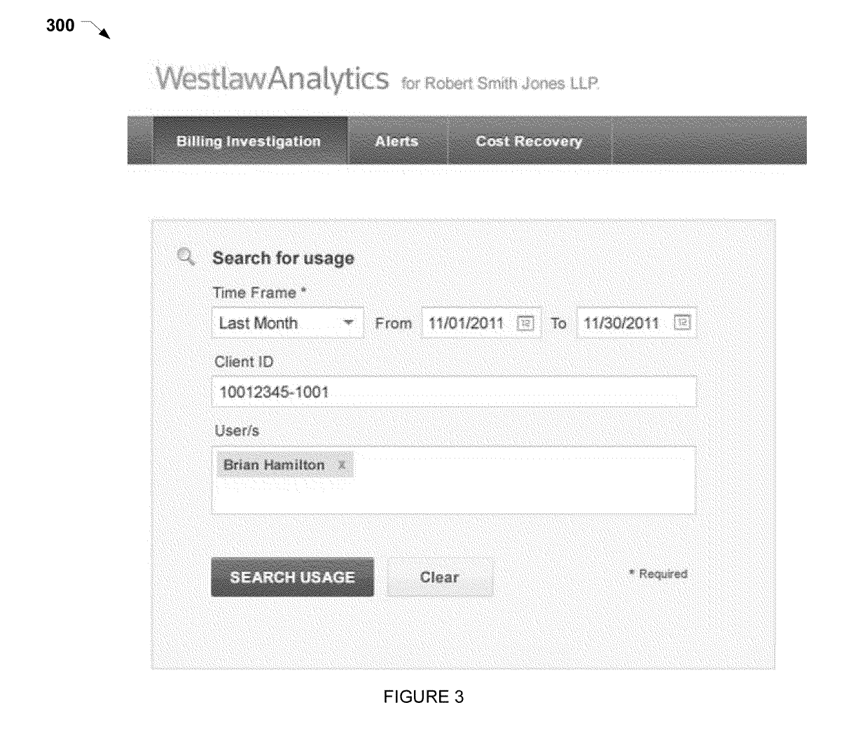

The description includes many terms with meanings derived from their usage in the art or from their use within the context of the description. However, as a further aid, the following definitions are presented. An administrator (herein also referred to as an admin) utilizes the systems, methods and interfaces described herein while a research user, on the other hand, utilizes an online research system (also referred to herein as “research system” and/or “research module”). Examples of administrators and research users are discussed throughout the specification. An event investigation inquiry is a request sent from an access device to a server. There are two exemplary types of event investigation inquiries (herein also referred to as an inquiry or inquiries): admin-initiated and system-initiated. An admin-initiated inquiry includes the administrator inputting a set of criteria which a server receives in order to process the inquiry request. For an example of an admin-initiated inquiry, reference FIG. 3 and corresponding description. A system-initiated inquiry has the access device initiate the inquiry, without admin input, which the server receives in order to process the inquiry request. For example, a system-initiated inquiry is created and sent, after a successful login, to the server associated with a research system. Exemplary inquiries are further explained within the written description.

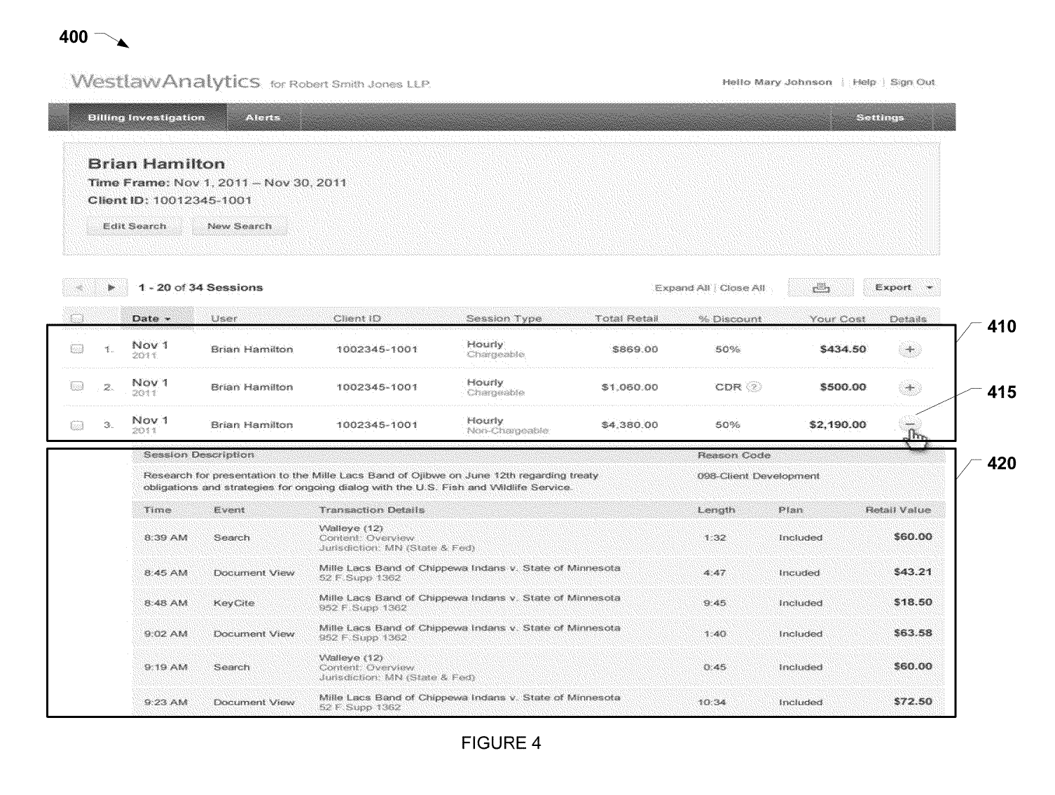

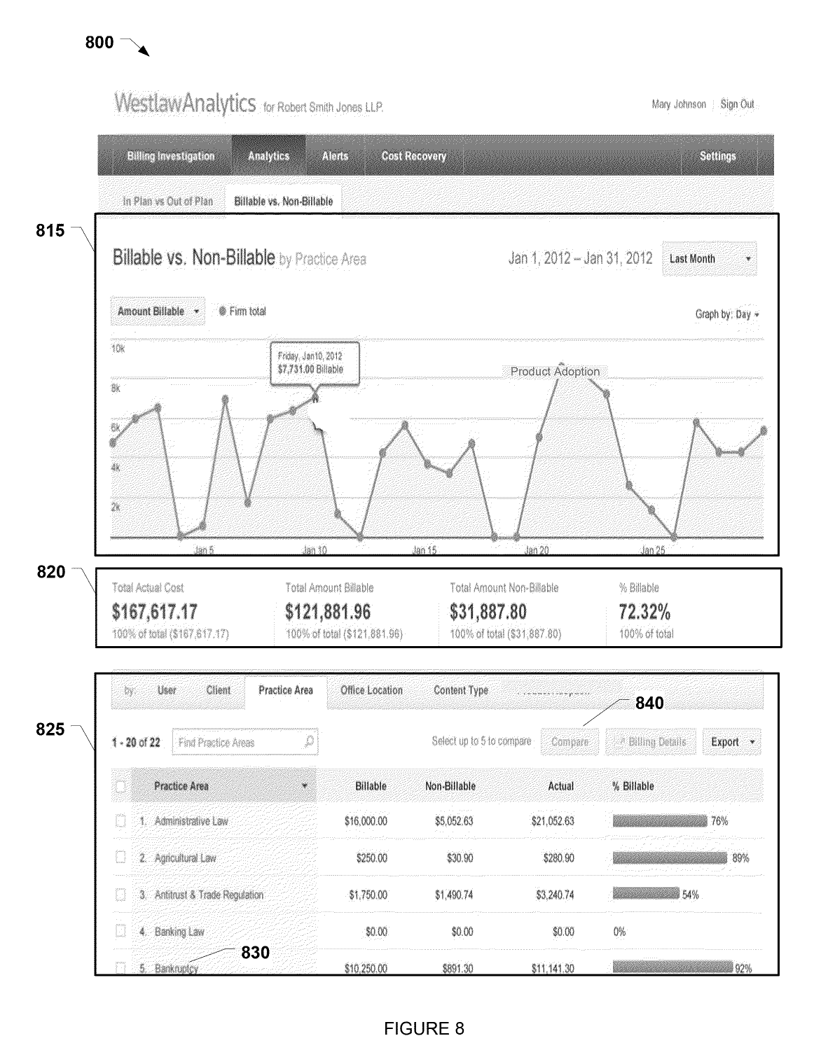

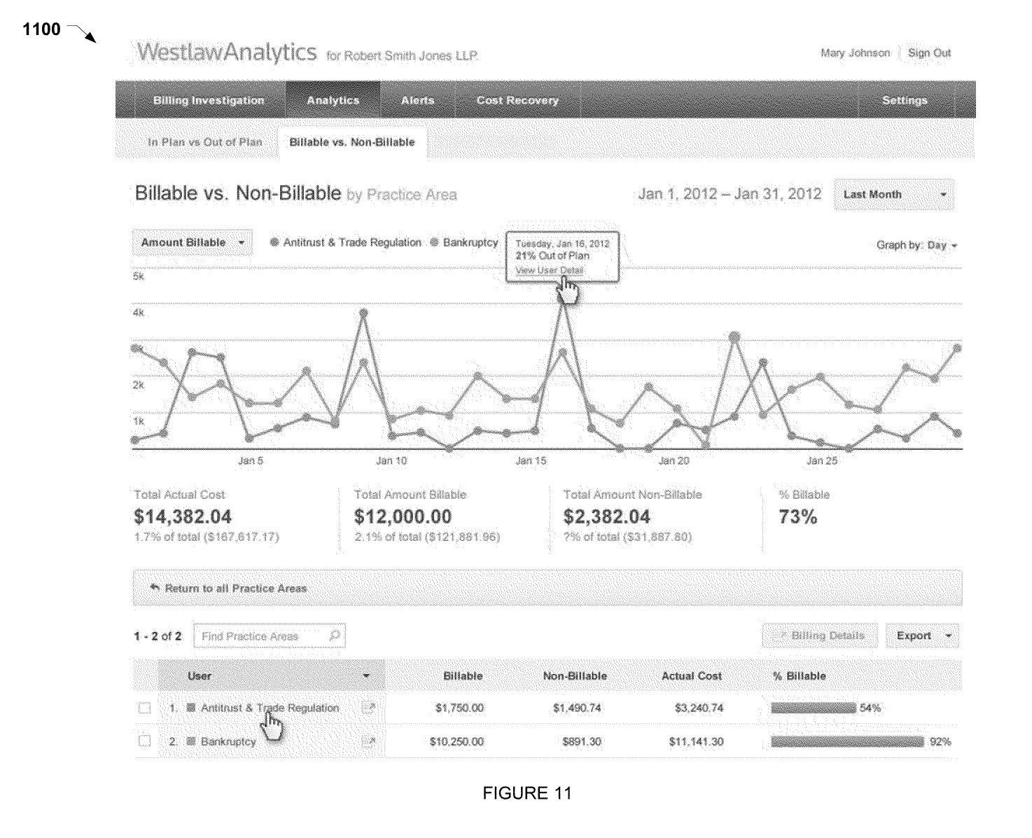

A research event is an action within a research system. Exemplary types of research events include billing events and user experience events. A billing event is associated with a research system charge. For example, the research system may charge to view a document. Therefore the document view action is a billing event for which there is an associated research system charge. A user experience event is an action that is not necessarily associated with a research system charge. In other words, anything that a research user clicks while utilizing the research system may be considered a user experience. Exemplary user experience events within a research system include but are not limited to accessing a folder, sharing a folder, filtering a set of search results and annotating a document and/or folder. Exemplary research event information may be individual pieces of information such as a research system charge for viewing a document and/or categorized information such as a practice area, a user name, a client ID, a content type, an office location, a subscription plan and billable charges. Exemplary individual pieces of information are described throughout the specification and illustrated in FIGS. 4-12. Exemplary categorized information is explained herein with legal based examples. One skilled in the art would recognize that this information could be adapted for other business areas such as the financial, scientific, tax and accounting areas. Exemplary practice area information is data relating to a given law firm's practice areas. Examples of practice areas are shown in FIGS. 8 and 11. Exemplary user name information is data relating to a given set of research users within a given law firm. Examples of user name information are shown in FIGS. 4-7, 9-10, and 12. Exemplary client identifier (ID) information is data relating to a unique reference for a given client. For example, if law firm X represents company B, then a client ID for company B may be “10012345.” In another example, if law firm X represents company B for a products liability case, then a client ID may include not only include “10012345” but also a matter identifier “1001.” Therefore, the full client ID for this example would be “10012345-1001.” Exemplary office location information is data relating to the office locations of a given law firm. For example, a law firm may have offices all over the world. The office location information maps each research user of the law firm resides with a law firm office location. Exemplary content type information is data relating to the different types of content to which a law firm has access to in a research system. For example, in a legal research system, exemplary content type information may be data relating to caselaw, statutes, and treatises to which a law firm has access in the research system. Exemplary subscription plan information is data relating to what content is included in a research user's subscription plan (referred to herein as “in plan”) and what content is not included in the subscription plan (referred to herein as “out of plan”) within a research system. For example, if the law firm ABC's subscription plan within a legal research system only includes Minnesota caselaw content, any Minnesota case is considered in plan while a national treatise is considered out of plan. Examples of subscription plan information are shown in FIGS. 4-7. Exemplary billable and non-billable charge information is data relating to research system charges that can be billed to a client (referred to herein as “billable”) and research system charges that are not billed to the client (referred to herein as “non-billable”), respectively. For example, if a research user is viewing a document for a summary judgment brief, the given research system charge is billed to the appropriate client. If, however, the research user begins to search for a treatise because he/she is writing a journal article, the given research system charge is not billed to a client but instead is borne by the law firm. Examples of billable and non-billable charge information are shown in FIGS. 8-12. An aggregated set of research event information combines at least the two sets of research event information. In some instances, a first and second set of research event information are combined to form an aggregated set. In other instances, more than two sets of research event information are combined. A stored aggregated set of research event information is an aggregated set of research event information that resides within an aggregating module. While the aggregating module is discussed in further detail later in the specification, the aggregating module is not only configured to aggregate a set of research event information but may also be configured to store an aggregated set of research event information.

In some embodiments, additional terms are used. Definitions of these additional terms are presented. Law firm information is a specific type of information that is received from a law firm and/or a system that can retrieve law firm information. Exemplary law firm information includes timekeeper identifiers, reason codes, practice areas within the given law firm, billing codes and the like. Refer to the third party information section of the written description for a further explanation. A law firm account code is unique vendor identifier within a payment based research system. The research system accesses the terms of the negotiated subscription and determines the associated charge for each research user's research event related to the law firm account code.

### Exemplary System

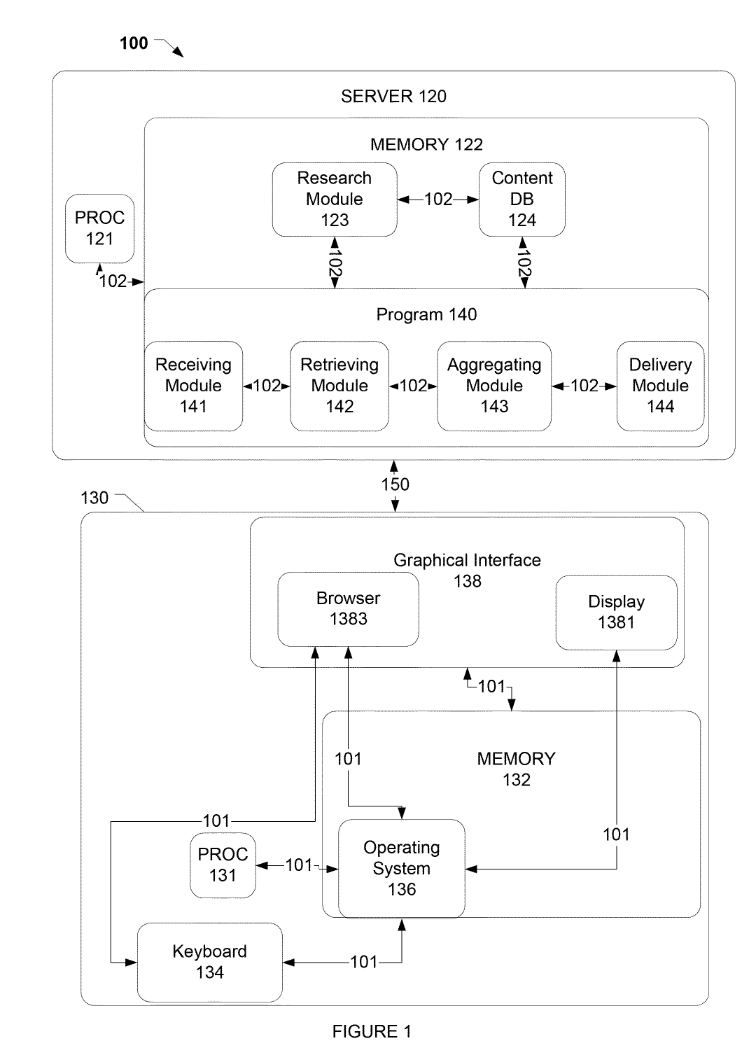

FIG. 1 shows an exemplary system 100 which may be adapted to incorporate the capabilities, functions, methods, and interfaces of the present invention. System 100 includes a server 120 and an access device 130.

Server 120 is generally representative of one or more servers for serving data in the form of a webpage or other markup language with associated applets, ActiveX controls, and/or other related software and data structures. In addition, server 120 transmits a signal via a wireless or wireline transmission channel 150 to at least one access device, such as access device 130. Server 120 includes a processor module 121 and a memory 122, wherein the memory 122 further includes a research module 123, a content database 124, and a program 140 with software modules 141, 142, 143 and 144. As shown in FIG. 1, in one embodiment, the software modules include a receiving module 141, a retrieving module 142, an aggregating module 143 and a delivery module 144. Details of the software modules 141, 142, 143 and 144 configured in memory 122 are discussed in further detail below. Processor module 121 and memory 122 are connected via computer bus 102, which is shown in server 120. Computer buses 101 and/or 102 are buses that transmit information between the server's components/elements, the access device's components/elements and/or between multiple access devices. For example, computer bus 101 and computer bus 102 aid in transmitting information (e.g., a signal) within access device 130 and server 120, respectively. Processor module 121 may use computer bus 102 to queue a request that is to be transmitted, from server 120, via a wireless or wireline transmission channel 150, to, ultimately, the processor module 131 through the utilization of computer bus 101. Generally, server 120 transmits the signal via a wireless or wireline transmission channel 150 to at least one access device, such as access device 130.

Processor module 121 includes one or more local and/or distributed processors, controllers and/or virtual machines. In the exemplary embodiment, processor module 121 takes any convenient and/or desirable form known to those skilled in the art. Memory 122 takes the exemplary form of one or more electronic, magnetic, and/or optical data-storage devices and stores a research module 123, a content database (DB) 124 and a program 140 with software modules 141, 142, 143 and 144.

Research module 123 includes one or more online search engines and related user-interface components (not shown), for receiving and processing queries against content database 124. An exemplary research module 123 is described in U.S. patent application Ser No. 11/538,749 entitled “Systems, Methods, And Software For Identifying Relevant Legal documents.” This application is herein incorporated by reference. In a preferred embodiment, the research module 123 is a payment based research system. For example, a research user may be charged a fee for executing a search, viewing a document and/or printing the viewed document. The fee may be subscription based, pay-as-you-go or discounted.

Content database 124 takes the exemplary form of one or more electronic, magnetic, and/or optical data-storage devices. Content database 124 includes content, data and/or information associated with research events, event investigation inquiries, sets of research event information, aggregated sets of research event information, results, research queries, caselaw, third party information and/or any other data needed to use system 100 and implement method 200. The content, data and/or information may be related to legal, financial, scientific, tax and/or accounting areas. Examples of content, data and/or information are described throughout the specification. The content and/or a subset of the content within the content database 124 may be subscriber content. Subscriber content includes content and related data for controlling, administering, and managing pay-as-you-go and/or subscription based access. For instance, a research user may have to subscribe to research module 123 (e.g., WestlawNext™). The content is stored in the content database 124 and cannot be accessed until a set of user credentials is authenticated. For instance, user credentials may be a user name and associated password. Once the credentials are successfully authenticated on server 120, a delivery signal is transmitted via the wireless or wireline transmission channel 150 to access device 130. For purposes described herein, successfully authenticating a set of user credentials means the user credentials were accepted by an authentication system (not shown but well known to those skilled in the art).

Access device 130 is generally representative of one or more access devices. In addition, access device 130 may be mobile or non-mobile. For example, a mobile and/or non-mobile access device may take the form of a personal computer, workstation, personal digital assistant, mobile telephone, smartphone, APPLE® iPad, and/or any other device capable of providing an effective user interface with a server and/or database. Specifically, in this exemplary embodiment, access device 130 is a personal computer which includes a graphical interface 138, a processor module 131, a memory 132, and a keyboard 134. All of these elements are connected via computer bus 101, which is shown in various pathways throughout the access device 130.

Processor module 131 includes one or more processors, processing circuits, and/or controllers. In the exemplary embodiment, processor module 131 takes any convenient and/or desirable form known to those skilled in the art. Coupled, via computer bus 101, to processor module 131 is memory 132.

Memory 132 and hard drive (not shown) are examples of main memory and secondary memory, respectively. In this document, the terms “computer program medium,” “computer usable medium,” and “computer readable medium” may generally refer to media such as main memory, secondary memory, removable storage drive, a hard disk installed in a hard disk drive and/or other media known to those skilled in the art. The computer readable medium, for example, may include non-volatile memory, such as a floppy disk, ROM, flash memory, disk drive memory, a CD-ROM, a CD-optical drive or disc and/or other permanent storage. Additionally, a computer readable medium may include, for example, volatile storage such as RAM, buffers, cache memory, and/or network circuits. The processor module 131 reads data, instructions, messages or message packets, and other computer readable information from the computer readable medium.

In one exemplary embodiment, memory 132 stores code (machine-readable or executable instructions) for an operating system 136. Operating system 136 is coupled to a graphical interface 138 and other various components thereof, via computer bus 101. In the exemplary embodiment, operating system 136 takes the form of a version of the MICROSOFT® WINDOWS® operating system, and browser 1383 takes the form of a version of MICROSOFT® INTERNET EXPLORER®. In addition, operating system 136 interacts, via computer bus 101, with the keyboard 134 and the processor module 131. For example, the keyboard 134 sends inputs, via computer bus 101, to the operating system 136. The operating system 136 then determines which one or more of the software modules 141, 142, 143 and 144 needs to be utilized, engages the given software module through the signal via a wireless or wireline transmission channel 150, accepts the software module output as data and stores that data temporarily in memory 132 (e.g., RAM). Operating system 136 and browser 1383 not only receive inputs from keyboard 134, but also support rendering of graphical user interfaces within graphical interface 138.

Graphical interface 138 includes a browser 1383 and a display 1381. When the functionality of one or more of the software modules 141, 142, 143 and 144 is initiated, a display 1381 is defined in memory 132 and rendered on graphical interface 138. Upon rendering, the graphical interface 138 presents the data/results in association with the set of instructions from the delivery module 144 as further discussed herein.

### Exemplary Method as Conducted by System 100

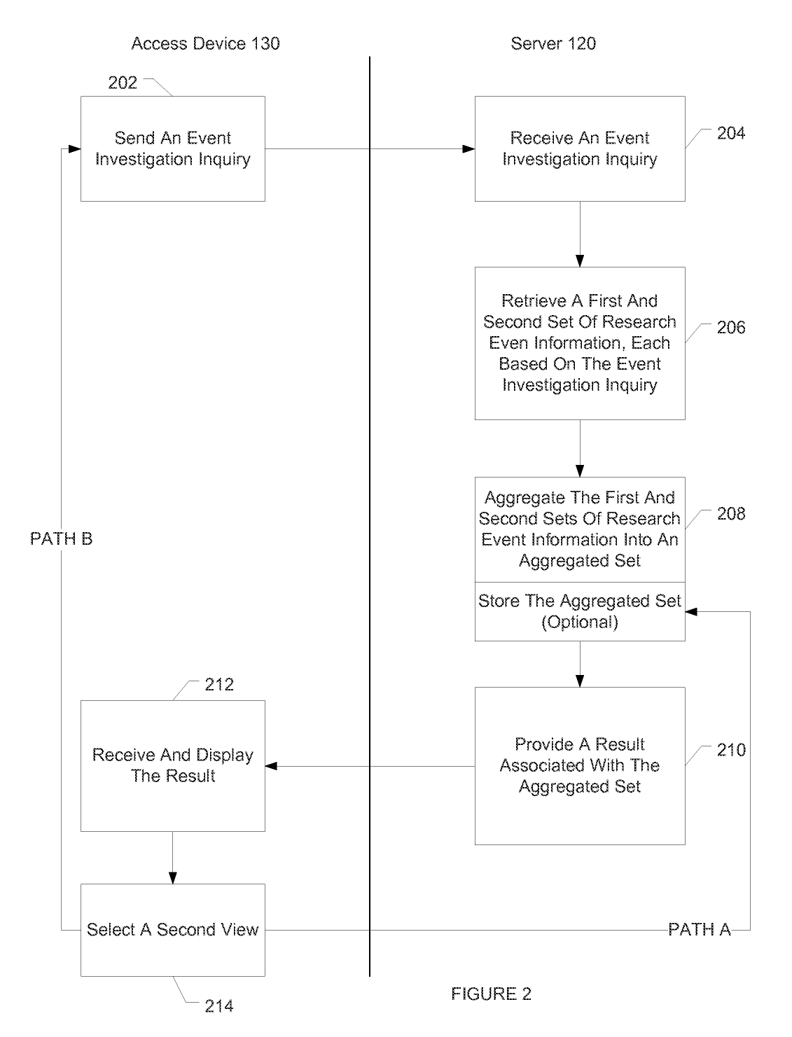

Referring now to FIG. 2, system 100 is configured to implement method 200. Method 200 includes functional blocks 202-214. These functional blocks are steps that perform actions including assignments, decisions, assessments and other like functions. In the following exemplary embodiments for method 200, an exemplary research module 123 is a legal research system such as WestlawNext™. Therefore, the examples discussed are related to legal research events and information. One skilled in the art should appreciate that research events and information may vary depending on the business area (financial, scientific, tax, accounting and the like). In addition, an administrator utilizes program 140 while a research user utilizes research module 123. In some cases, a given entity may be a research user and an administrator. For instance, a research user may be utilizing the research module 123 and, if the research user also has the proper administrative credentials, may then engage the program 140 as an admin. Administrative credentials are discussed herein.

Prior to method 200 commencing, an administrator needs to log into program 140 from access device 130. In a preferred embodiment, the program 140 is associated with the research module 123. Therefore, the user credentials that are used for accessing the research module 123 may also be used to access the program 140. Successful access to the program 140 entitles the admin to view any information in which he/she is privy. For instance, a law librarian may be designated as the administrator for law firm X. In order for the designation to occur, a certain number of unique registration keys are given to law firm X when subscribing to the research module 123. A unique registration key is a unique identifier that is associated with a research system subscription and related research system functionality for which law firm X has paid. The research module 123 indicates that a certain unique registration key is designated with an admin access type. Thus, the designated law librarian would be associated with the admin unique registration key. Since a given set of unique registration keys are associated with law firm X, the admin has access to the research users' usage information associated with law firm X. Once an admin successful logs into program 140, step 202 initiates.

In step 202, an event investigation inquiry is sent from access device 130 to server 120 via wireline or wireless transmission channel 150. In a preferred embodiment, there are two previously defined types of event investigation inquiries: admin-initiated and system-initiated. Since the system-initiated inquiry does not require admin input, a default set of criteria may be associated with the system-initiated inquiry. For instance, a system-initiated inquiry may request all research events for the entire law firm for the last month. Even if the system-initiated inquiry does not have the desired criteria, the admin, in later interfaces and functionality, may elect to navigate to other views in order to see the preferred information. Regardless of inquiry type, the access device 130, in particular browser 1383, takes the inquiry and generates a signal including the inquiry (not visible to the user). Next, browser 1383 sends the inquiry by transmitting the signal to server 120 via wireline or wireless transmission channel 150. After the inquiry is sent to server 120, the process progresses to step 204.

In step 204, the event investigation inquiry is received by server 120. In particular, the signal including the event investigation inquiry is received by the receiving module 141 in program 140. The program 140 is stored in memory 122 for execution by processor 121. In some embodiments, the receiving module 141 needs to extract the event investigation inquiry information from the signal format. For example, in order for the signal to be transmitted via wireline or wireless transmission channel 150, the signal needs to be in a format that permits transmission. The format may require that the inquiry be encrypted to prevent electronic theft during the transmission process. Encryption and decryption techniques are known to those skilled in the art. Therefore, when the signal is received, the receiving module 141 may need to de-crypt the signal. The receiving module 141 then looks for the inquiry information residing within the de-crypted signal and extracts it. Once the event investigation inquiry has been received, the process moves to step 206.

In step 206, a first set of research event information based on the event investigation inquiry is retrieved by the retrieving module 142. The first set of research event information is associated with a first research event. Additionally in step 206, a second set of research event information based on the event investigation inquiry is retrieved by the retrieving module 142. The second set of research event information is associated with a second research event. The retrieving module 142 receives the event investigation inquiry from the receiving module 142 via computer bus 102. The event investigation inquiry contains criteria the retrieving module 142 uses to retrieve a given set of research event information for a given research event from content database 124. For example, if the inquiry contained the following criteria: 1) law firm ABC account code and 2) timeframe within last month, the retrieving module 142 would retrieve all research events and the corresponding research event information relating to the given criteria. For instance, assuming the current criteria, there are two research events: a search event and a document view event. The retrieving module 142 retrieves a first research event (the search event) and a second event (the document view event) along with a first and second set of research event information associated with the first and second research events, respectively. An exemplary set of research event information includes at least one of: a timestamp, a date, a user name, a client identifier, a practice area, a location, a research session type, a research session description, a reason code, an event description, a transaction detail, a percentage indication, a research session length, a billable event indication, a subscription plan indication, a total cost value, a discount percentage, a discounted cost value and the like. Research event information and research events are described and illustrated further in FIGS. 4-12. Therefore, each research event (e.g., search event and document view event) has a set of research event information associated with it. Furthermore, each of the first and second research events in the present example is a billing event. In some embodiments, the research events may not be related to billing but instead a user experience. As stated previously, a user experience event is an action that is not necessarily associated with a research system charge. In other words, anything that a research user clicks while utilizing the research system may be considered a user experience. Exemplary user experience events within a research system include but are not limited to accessing a folder, sharing a folder, filtering a set of search results and annotating a document and/or folder. In some instances, a document view event is considered a billing event but may also be considered a user experience since the user did click on the document link in order to view the document. A set of research event information is based on an event investigation inquiry and associated with a research event. User experience events include but are not limited to folder access, sharing, filtering and annotating. In other words, anything that a research user clicks while in the research module 123 may be considered a billing event and/or user experience. For instance, a document view event may be considered not only a billing event because the research user is being charged for viewing the document but may also be considered a user experience since the user did click on the document link in order to view the document. Referring back to the example of a search event and a document view event, while this example and method 200 generally refer only to two research events and their corresponding set of research event information, one skilled in the art would appreciate that three, four, or n research events and associated sets of research event information may be retrieved from content database 124 by the retrieving module 142 depending on the inquiry. After the retrieval of the first and second sets of research event information is complete, the process advances to step 208.

In step 208, the first and second sets of research event information are aggregated into an aggregated set of research event information by the aggregating module 143. Aggregation techniques are known to one skilled in the art. The aggregating module 143 receives the first and second sets of research event information from the retrieving module 142 via computer bus 102. In some embodiments, during aggregation, calculations may need to be done for display purposes. For example, if the first set of research event information includes a total out of plan amount for research user X and the second set of research event information includes a total out of plan amount for research user Y, the aggregating module 143 adds the totals together. This addition calculation is then ultimately displayed to the admin when, for instance, he/she is viewing the total out of plan costs for a law firm. In some embodiments, the aggregated set of research event information may be stored temporarily in the aggregating module 143. This temporary storage acts as a caching mechanism for when the browser 1383 needs to display the stored aggregated set of research event information. The browser 1383 interacts with the aggregating module 143 instead of the content database 124 for faster rendering and display purposes. In this current example, while the browser 1383 may interact with aggregating module 143 to retrieve the stored aggregated set of research event information, the delivery module 144 is the ultimate delivery mechanism for providing a result associated with the aggregated set of research event information to the browser 1383. Once the first and second sets of research event information are aggregated, the process continues to step 210.

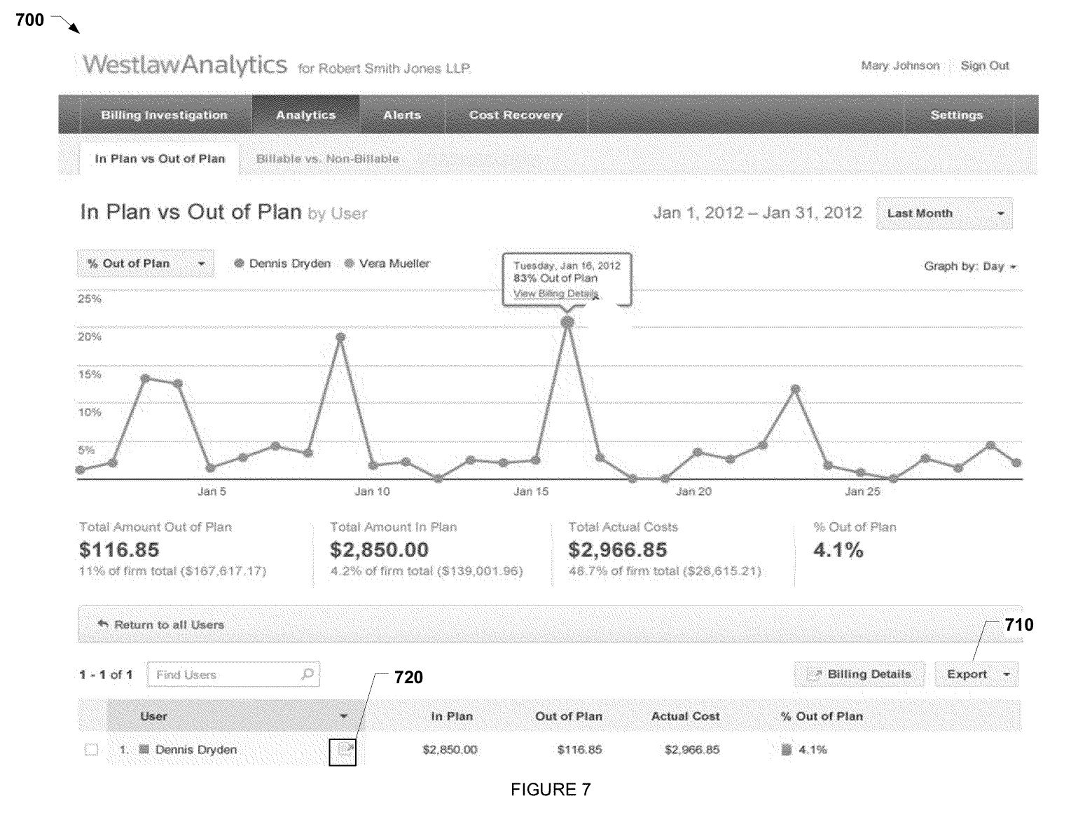

In step 210, a result in an interactive format that allows for one or more views is provided by the delivery module 144. The result is associated with the aggregated set of research event information and each view is associated with a different representation of the aggregated set of research event information. The delivery module 144 receives the aggregated set of research event information from aggregating module 143 via computer bus 102. The delivery module 144 applies a stylesheet to the aggregated set of research event information. A stylesheet determines what information from the aggregated set of research event information should be initially displayed to the admin once the result is provided. For example, the stylesheet may determine that only user name information should be initially displayed to the admin. See FIG. 7 for an example of user name information regarding Dennis Dryden. The practice area information may still be stored in the aggregating module 143. Therefore, if the admin wants to see the practice area information, the admin engages another view which then ultimately displays the practice area information. See FIG. 8 for an example of practice area information. FIGS. 7-8 show examples of two views displaying information in two different representations, user name representation and practice area representation, respectively. The fact that the admin has the capability to engage a second view from a first view illustrates that the result is in an interactive format. One indication that the result is in an interactive format is the presence of tabs and navigation buttons for the admin to navigate to other views. Reference FIGS. 4-12 for multiple views of exemplary results.

In some embodiments, the result is based on a set of administrative permissions. As discussed previously, the admin can only view the information to which he/she is privy. Thus, in some embodiments, if the admin is not allowed to see the research events for law partner X, for example, law partner X's usage is not shown within the result. While the retrieving module 142 may initially retrieve law partner X's usage per the inquiry, either the aggregating module 143 and/or the delivery module 144 may check to see if there are any filters (e.g., removing law partner X's usage) that should be applied before providing the result.

Referring back to providing the result, the server 120, in particular delivery module 144, takes the result and generates a signal including the result (not visible to the user). Next, the delivery module 144 sends the result by transmitting the signal to access device 130, in particular browser 1383, via wireline or wireless transmission channel 150. After the result is provided to access device 130, the process moves to step 212.

In step 212, the result is received and ultimately displayed on access device 130. In particular, the signal including the result is received by the browser 1383 within access device 130. In some embodiments, the browser 1383 needs to extract the result information from the signal format. For example, in order for the signal to be transmitted via wireline or wireless transmission channel 150, the signal needs to be in a format that permits transmission. The format may require that the result be encrypted to prevent electronic theft during the transmission process. As stated previously, encryption and decryption techniques are known to those skilled in the art. Therefore, when the signal is received, the delivery module 144 may need to de-crypt the signal. The delivery module 144 then looks for the result residing within the de-crypted signal and extracts it. The browser 1383 then renders and ultimately displays the result associated with the aggregated set of research event information. Reference FIGS. 4-12 for multiple views of exemplary results.

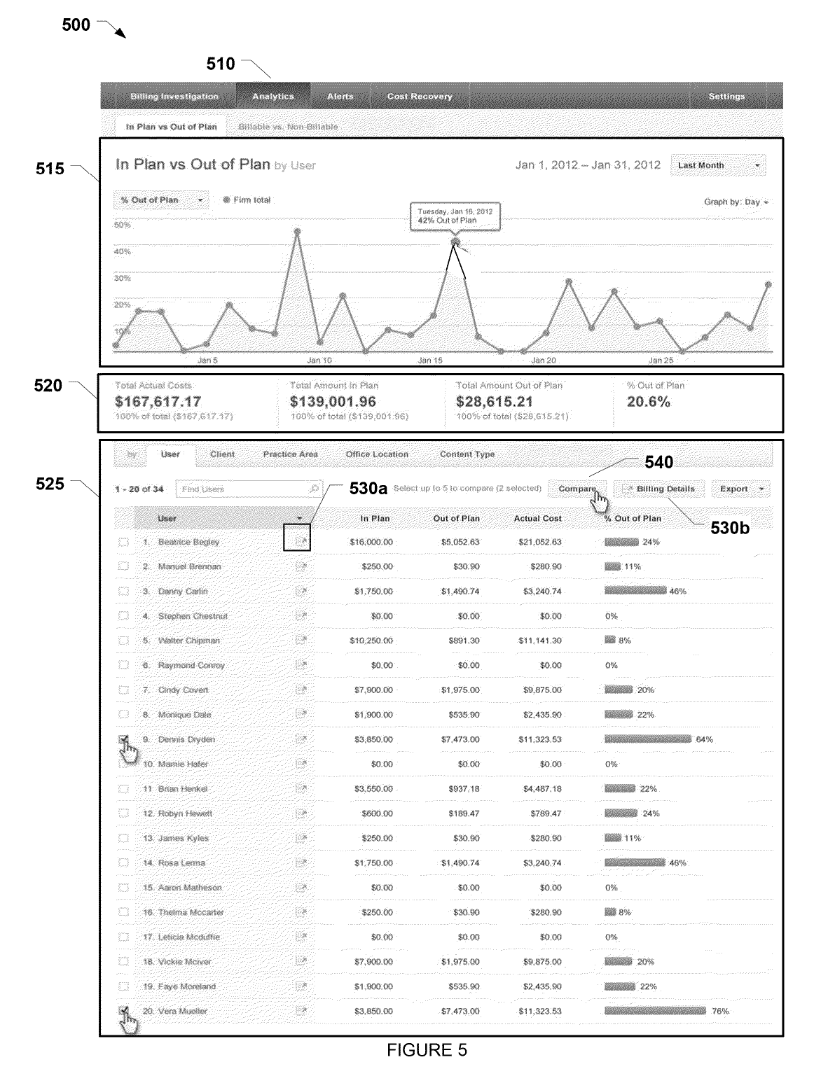

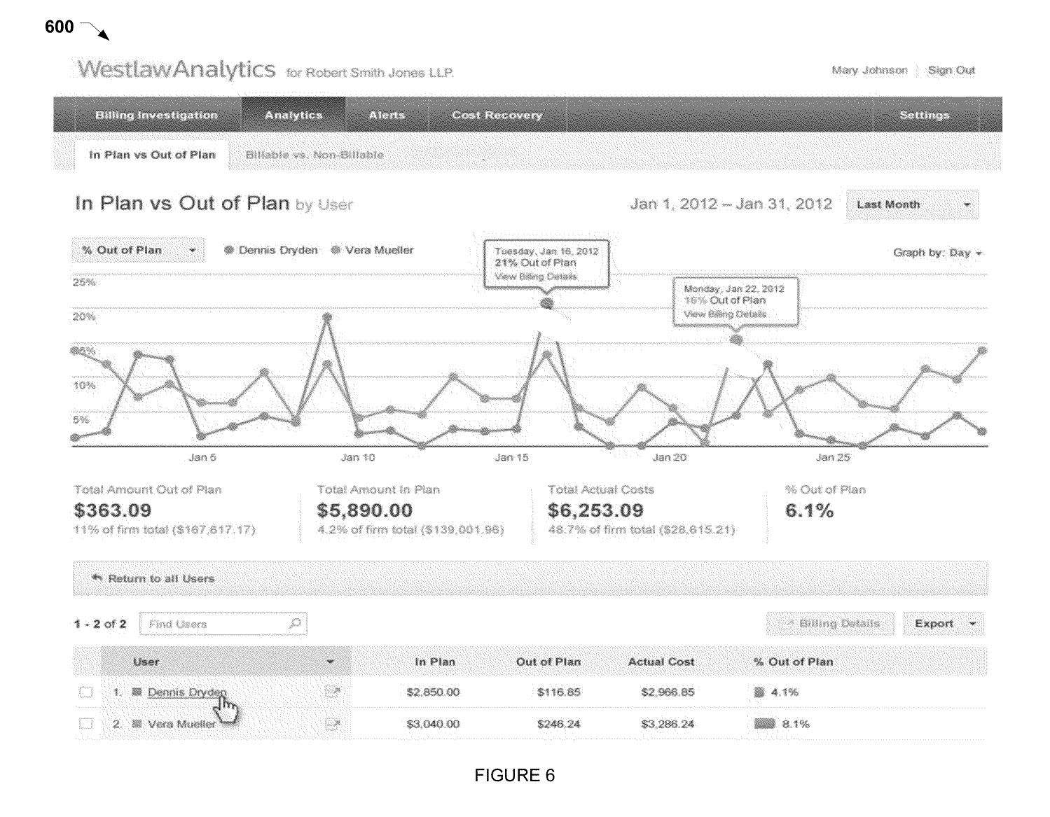

In some embodiments, the admin wants to select a second view of the aggregated set of research event information from within the first view. The first view is a first representation of the aggregated set of research event information. For example, a first view may be associated with a multiple-user representation. See FIG. 5 for a first view, multiple-user representation. Using the assumption that a first view of the result is provided by the delivery module 144 in step 210 and received and ultimately displayed in step 212, the admin selects a second view in step 214. Continuing from the previous example, since within the first view there are multiple research users represented, the admin may only be curious about a subset of research users. Therefore, the admin may select two research users to compare. See FIG. 6 for a second view, user comparison representation.

In the current example where the first view is a multiple-user representation, the first view displays a first representation associated with the aggregated set of research event information. When, in response to an admin selection, the second view of the result is provided by the delivery module 144, the second view becomes a second representation of the aggregated set of research event information. For instance, when the second view is about to be displayed due to admin selection, the browser 1383 either initiates Path A or Path B depending on the type of view. Assuming the second view would be the user comparison representation, the browser 1383 only needs additional information relating to the selected research users. Therefore, the browser 1383 only requests the additional information (Path A) from the aggregating module 143 and that additional information is provided by the delivery module 144 as a second view. The second view is associated with a second representation of a stored aggregated set of research event information (refer back to step 208). If, however, the information needed to display the second view is different information such as practice area, office location, content type, and/or billable, a new admin-initiation inquiry (Path B) needs to be made. The process then starts again with step 202 until the result in the second view with the different information is provided via the delivery module 144 to the access device 130, in particular browser 1383. Either way, the second view of the result is provided, in response to an admin selection, by the delivery module 144.

### Exemplary Interfaces

FIG. 3 represents exemplary interface 300 in which an administrator inputs an event investigation inquiry. Exemplary interface 300 is accessed by the admin on access device 130, in particular browser 1383. In this interface, the admin is looking to investigate the research usage within research module 123 for a particular set of research users for which this administrator has authorization. In FIG. 3, the administrator has entered “Last Month” in the Time Frame field by selecting from the drop down box wherein the From and To fields are automatically populated to the dates of the last month. The administrator has also inputted “10012345-1001” within the Client ID field and a user name “Brian Hamilton” within the User/s field. The admin inputting a set of criteria into the interface is an example of an admin-initiated inquiry. In some embodiments, some fields are required as indicated in FIG. 3 with an asterisk. For example, the Time Frame field has an asterisk to the right of the field name indicating that the administrator must input at least a time frame before clicking the Search Usage button. Once the administrator selects the Search Usage button, he/she may be navigated to exemplary result 400 in FIG. 4.

FIGS. 4-12 show exemplary results 400-1200 representing the one or more views of the present invention. In some exemplary views, some of the information may initially come from an exemplary law firm billing system. This law firm information is explained in further detail within the third party information section. FIG. 4 is an exemplary result 400 in an interactive format that allows for one or more views. For example, exemplary result 400 illustrates a listing of usage for Brian Hamilton regarding Client ID “10012345-1001” for the month of November 2011 (last month in FIG. 3). The exemplary result 400 is a first view which is a first representation 410 of Brian Hamilton's three research sessions (a set of research events). The first representation 410 is a summary representation that illustrates the aggregated set of research event information. In this instance, the exemplary aggregated set of research event information includes but is not limited to date, user name, client ID, session type, total retail price, percent discount, and law firm cost. In order for the admin to see a second view, for instance, he/she needs to engage the expand button 415 to render and display a second representation 420 that includes more detailed information regarding a given set of research events. This scenario is an example of method 200 executing Path A when the admin selects a second view with a detailed information representation (an exemplary second representation 420). These exemplary research events include two search events, three document view events, and one legal citation event (e.g., a WestlawNext™ KeyCite event). The detailed information regarding each research event includes but is not limited to time, event description, transaction details, transaction length, plan indication and retail value price. In addition, other detailed information includes overall research session details such as session description and reason code. While the exemplary result 400 is based on an admin-initiated inquiry, a similar exemplary result may be based on a system-initiated inquiry.

FIG. 5 is an exemplary result 500 that relates to an aggregated set of research event information based on a system-initiated inquiry. For instance, an admin logs into program 140. Upon logging in, the admin then selects the Analytics tab 510. This selection triggers a default inquiry (an exemplary system-initiated inquiry) of the last month regardless of user and/or client ID which in turn is sent to the receiving module 141 (refer to step 202 in method 200). The exemplary result 500 is in an interactive format that allows one or more views since there are tabs and hyperlinks that allow the user to navigate through the different views of the information. Each view of the information has a different representation. For example, in this first view, there are three sections: 1) graphical section 515, 2) summary section 520, and 3) detailed information section 525. Each are described herein. The graphical section 515 includes a graphical representation of the daily percentages of out of plan costs for all research users within the law firm. The admin may use a mouse to hover over a data point (e.g., a given day) within the graph which in turn displays the percentage of out of plan for the given day. The summary section 520 includes a set of summary information regarding total actual costs, total amount in plan, total amount out of plan and the percentage out of plan for all research users. The set of summary information is an exemplary subset of the aggregated set of research event information. The detailed information section 525 includes an exemplary listing of all the research users that utilized the research module 123 in the given last month. The exemplary listing includes detailed information about each research user such as user name, in plan costs, out of plan costs, actual cost and percent out of plan. While the first, default view is to show the aggregated set of research event information by research user, an administrator may select tabs such as Client, Practice Area, Office Location and Content Type within the detailed information section 525 relating to the aggregated set of research event information. As will be shown later in the specification, an admin may select one of the tabs to engage a second view of the aggregated set of research information. In some embodiments, the admin may want to see further details around a given research user. One way to engage a second view relating to the billing details of a given research user is to select the billing details icon 530a located to the right of the user name as shown in FIG. 5. Another way is to check the box to the left of the user name and then select the Billing Details button 530b. Either way, detailed information regarding the given research user is displayed in a second view with a similar or exact representation to FIG. 4. Yet another embodiment allows the admin to compare two items within the aggregated set of research information such as two exemplary users, Dennis Dryden and Vera Mueller. The admin selects the check box to the left of each user name along with then selecting the Compare button 540. Once the Compare button 540 has been selected, another view, FIG. 6, is rendered and displayed into a second representation for the admin. This is another example of method 200 executing Path A when the admin selects a second view with the user comparison representation.

FIG. 6 is an exemplary result 600 related to a second view associated with the user comparison representation of two exemplary users, Dennis Dryden and Vera Mueller. Similar to FIG. 5, the same three sections are shown. However, in this second representation, the graph no longer shows the out of plan percentage for the whole firm but instead shows a line for each of the compared research users. This allows the admin to visualize which research users utilizing the research module 123 are going out of plan and how frequently the given research user(s) are out of plan. This analysis ultimately guides the admin in determining if a given research user needs more education regarding the research module 123 or if the out of plan cost is just a single occurrence. In addition, this information and representation is very helpful in managing and possibly charging research costs to a client. For example, if a firm incurred $5,000 worth of research costs because of a nuance of a case, the admin has the ability to analyze the transaction details before authorizing an invoice to the client. If the admin wanted to see yet another view of the research user, Dennis Dryden, the admin selects his name which in turn would render and display a third view of only Dennis Dryden's information.

FIG. 7 is an exemplary result 700 relating to third view associated with a third representation which includes only Dennis Dryden's information. While the third representation is similar in display to FIGS. 5-6, in FIG. 7, only the stored aggregated set of research information related to Dennis Dryden is shown to the admin. This is yet another example of method 200 executing Path A when the admin selects a third view with the selected user representation. As stated previously, the admin may select the billing details icon 720 at any time to be navigated to a view wherein further transaction details are provided. In addition, several views allow the admin to export the aggregated set of research information. For example, the admin may select the check box to the left of Dennis Dryden's name and then the admin may select the Export button 710. Once the Export button 710 is selected, a pop-up window (not shown) appears to the admin so that he/she may select a format for which the information about Dennis Dryden may be exported. For instance, in some embodiments, only the textual information is exported to an exemplary Microsoft® Excel file. In other embodiments, the graphical information in addition to the textual information is exported to an exemplary image file.

In some embodiments, an admin may be looking at FIG. 7 but may now wish to see a different view of the information. For example, the admin is currently looking at the aggregated set of research event information as it relates to in plan vs. out of plan by user name. The admin may now want to see the aggregated set of research event information as it relates to billable vs. non-billable events by practice area. While all of the information relates to the aggregated set of research event information, different views allow the admin to see different representations. If the admin selects billable events by practice area, method 200 would execute Path B when the admin selects a second view with the practice area representation. This representation is illustrated in FIG. 8.

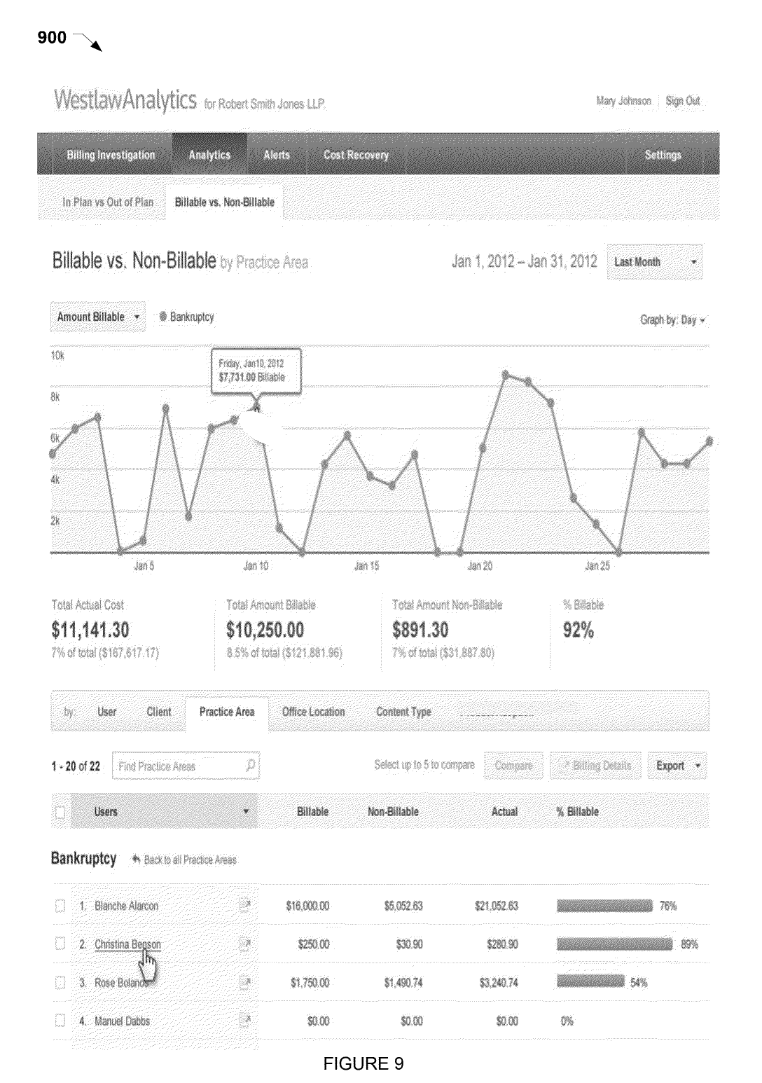

FIG. 8 is an exemplary result 800 relating to billable vs. non-billable research events by practice area. While FIG. 8 may be considered a fourth view depending on the navigation of the admin, assume in this embodiment that the view in FIG. 8 is the first view for simplification purposes. In this first view, the admin sees information regarding billable vs. non-billable research events by practice area. For example, in this first view, there are three sections: 1) graphical section 815, 2) summary section 820, and 3) detailed information section 825. Each section is described herein. The graphical section 815 includes a graphical representation of the daily billable costs by for all research users within the law firm. The admin may use a mouse to hover over a data point (e.g., a given day) within the graph which in turn displays the billable costs for the given day. The summary section 820 includes a set of summary information regarding total actual costs, total amount billable, total amount non-billable and the billable percentage for all research users. The set of summary information is an exemplary subset of the aggregated set of research event information. The detailed information section 825 includes an exemplary listing of all the practice areas that utilized the research module 123 in the given last month. The exemplary listing includes detailed information about each practice area such as practice area name, billable amount, non-billable amount, actual cost and billable percentage. While the current view is to show information by practice area for billable vs. non-billable costs, an administrator may select several tabs relating to the information such as User, Client, Office Location and Content Type. If the admin wants to engage another view around a given practice area, the admin may select the hyperlinked bankruptcy practice area name 830. Once selected, method 200 executing Path A is triggered and FIG. 9 is ultimately displayed to the admin.

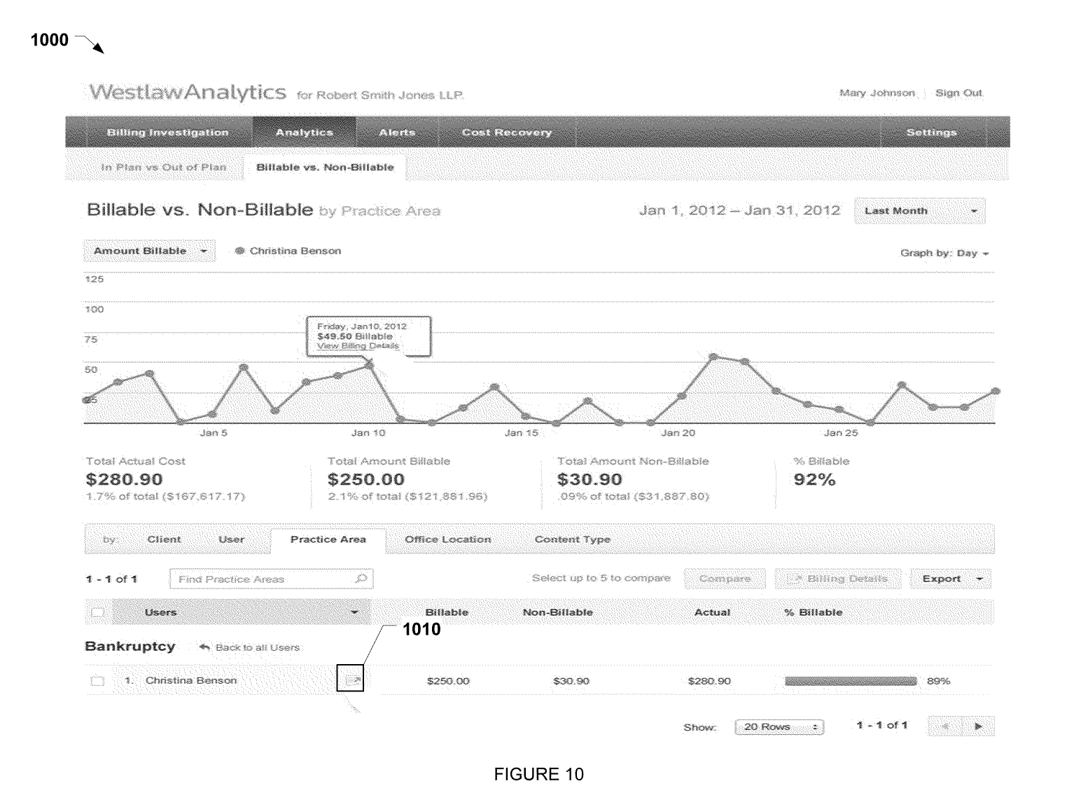

FIG. 9 is an exemplary result 900 relating to a selected bankruptcy view (an exemplary second view) of the aggregated set of research information. Similar to FIG. 8, the practice area information is shown. However, in this representation, the graph no longer shows the billable costs for the whole firm but instead shows a line of billable costs for the bankruptcy practice area. Again all views give an admin a better understanding of how research users, practice areas, office locations and the like are billing their time when it comes to research module 123. This attention to detail provides the firm with in-depth, transparent information regarding research system charges. In addition, the transparency aspect allows the firm to have an open conversation with the client and lawyer(s) about these research system charges. Referring back to the selected bankruptcy view, the admin may choose to select a specific user within the practice area. Once selected, method 200 executing Path A is triggered and FIG. 10 is ultimately displayed to the admin.

FIG. 10 is an exemplary result 700 relating to the third view associated with a third representation of only Christina Benson's information. While the third representation is similar in display to FIGS. 8-9, in FIG. 10, only the stored aggregated set of research information related to Christina Benson is shown to the admin. This is yet another example of method 200 executing Path A when the admin selects a third view with the selected user representation. As stated previously, the admin may select the billing details icon 1010 at any time to be navigated to a fourth view wherein further transaction details (similar to FIG. 4) are provided.

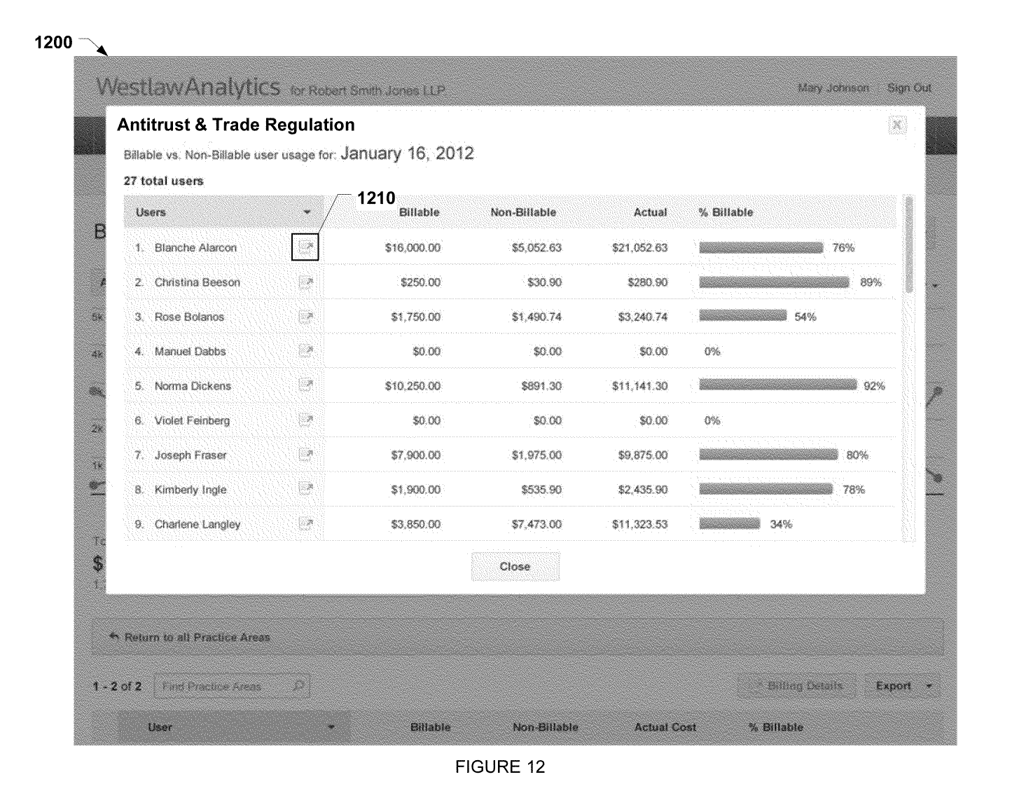

FIG. 11 is an exemplary result 1100 related to a fourth view and representation of two exemplary practice areas, Antitrust & Trade Regulation and Bankruptcy. In order to get to this view, a reference is made to FIG. 8 wherein the admin selects two practice areas, Antitrust & Trade Regulation and Bankruptcy, and then clicks the Compare button 840. While similar to FIG. 9, in this fourth representation, the graphical section no longer shows the billable costs for the whole firm but instead shows a line of billable costs for each of the selected practice areas. This representation allows the admin to understand which practice areas within the firm are billing and/or not billing the research system charges from research module 123. If the admin chooses to select a point from the graph, a pop-up window appears which navigates the admin to FIG. 12. Once selected, method 200 executing Path A is triggered and FIG. 12 is ultimately displayed to the admin.

FIG. 12 is an exemplary result 1200 relating to research usage for a given day around a given practice area. In this example, the given day of Jan. 16, 2012 was chosen by the admin. The admin now has a fifth view and representation which relates to the research usage on Jan. 16, 2012 for the research users in the antitrust and trade regulation practice area. As stated previously, the admin may select the billing details icon 1210 at any time to be navigated to a view wherein further transaction details are provided.

### Third Party Information

In some embodiments, the research module 123 does not have all the information necessary to present to the administrator. Therefore, some the information and relationships are provided by a third party to the research module 123 so that all the information around the research events may be shown to the admin. For example, the research module 123 may only know a research user by a unique registration key and the research user-inputted user name. The research module 123 also knows that for a given account code associated with a law firm there is a set of unique registration keys. For instance, when subscribing to the research module 123, the law firm, via its account code, may be given ten (10) unique registration keys based on the negotiated price. The law firm then distributes the keys to particular law firm personnel. While the law firm knows the association between each key and law firm personnel, these associations are not initially known to the research module 123. Therefore, there may be ways to inform the research module 123 of these associations which in turn can provide a better experience for the admin when looking at exemplary results. One way is for the law firm to provide the research module 123 with a listing of law firm information. This law firm information may be incorporated as a given user is using the research module 123. For instance, a law firm may upload a spreadsheet (Table 1) to the research module 123.

TABLE 1
Law Firm ABC Information Spreadsheet

| Timekeeper ID | Practice Area | Reason Code | Client ID |
|---|---|---|---|
| TK001 | Bankruptcy | Bar Journal | 999 |
| TK002 | Estate | Client Development | 1022-332 |
| TK003 | Business Law | Research | 1001-1234 |

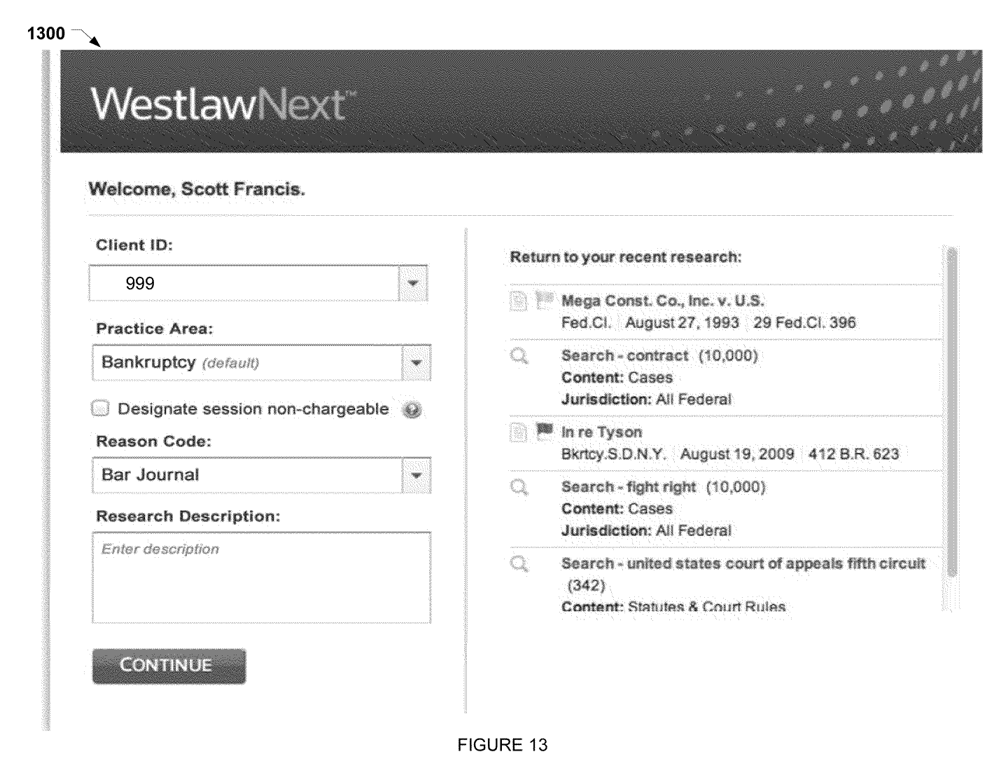

Table 1 shows three timekeeper identifiers, three practice areas, three reason codes and three client identifiers for law firm ABC. A reason code is a research type categorization within the research module 123. For example, a reason code may be general such as research as shown in Table 1. Another exemplary reason code may be more specific such as bar journal. When a more specific reason code is selected, for example the bar journal, the research module 123 categorizes the research events as researching for a bar journal article. Since the information is provided by the law firm, the reason codes may be as general and/or specific as needed by the given firm. The information in Table 1 is then stored in the content database 124 and related to law firm ABC's account code in the research module 123. For instance, if law firm ABC uploads its information to content database 124, the law firm ABC information is then related to the law firm ABC's account code for the research module 123. This way when a research user logs in with a unique registration key associated with law firm ABC and its account code, an interface with the law firm ABC information may appear to the research user. In FIG. 13, an exemplary interface 1300 illustrates a representation of law firm ABC's information. For example, as the research user is about to perform a search event with research module 123, interface 1300 appears requiring the research user to input and/or select some law firm ABC information. For instance, in the current example, the research user has selected the client ID 999 which, when referenced from Table 1 above, is related to timekeeper ID TK001 (not shown in FIG. 13). In addition, the practice area, bankruptcy, is selected for the research user as a default practice area since the research module 123, via the content database 124, understands that TK001 timekeeper is associated with the bankruptcy practice area in Table 1. Furthermore, the research user has selected the reason code as bar journal. The research user may also choose to enter a description of the event (e.g., research) which may be displayed later in the detailed information (a reference to event description is illustrated in FIG. 4 and its corresponding description).

Another way for the law firm to provide law firm information to research module 123 is to establish an interaction with a law firm's billing system (for example, Thomson Reuters Elite™ 3E) and the research module 123. Exemplary billing systems are described in U.S. patent application Ser. No. 12/283,959 entitled “ELECTRONIC BILLING SYSTEM UTILIZING A UNIVERSAL BILLING FORMAT DATA TRANSMISSION” and U.S. patent application Ser. No. 11/368,370 entitled “INTEGRATED SYSTEM, TOOLS AND METHODS FOR DESIGNING AUTOMATED BUSINESS PROCESS APPLICATIONS.” Each application is incorporated by reference herein. One way to establish the interaction between the law firm's billing system and the research module 123 is to create an application programming interface (API). An API is a protocol intended to be used as an interface by software components (e.g., a billing system and a research module 123) to communicate with each other. For example, the law firm enters the law firm information into the billing system and the API communicates the entered law firm information to the research module 123. An API can be created easily if the research module 123 and the billing system are associated with the same company. Even though the law firm information is being pulled from a billing system instead of being uploaded by a member of a law firm, the law firm information provided to the research module 123 is the same. In some cases, the billing system may be able to provide more law firm information since there is less human investment is creating the spreadsheet and providing updates to the given law firm information.

The embodiments described above and in the claims are intended only to illustrate and teach one or more ways of practicing or implementing the present invention, not to restrict its breadth or scope. For example, while no exemplary results illustrate office location and/or content type information, one skilled in that art would appreciate how the office location and/or content type information could be displayed for an admin given FIGS. 4-12. In another example, the browser 1383 may not be sending/receiving signals from the server 120, thus, not displaying a result. Instead an installed application within the memory 132 may be communicating with server 120 via wireline or wireless transmission channel 150. Therefore, display 1381 may ultimately show a given result in this scenario. For example, FIG. 1 shows browser 1383 and display 1381 as having the ability to display simultaneously; however, in operation, some embodiments may present them at separate times. The actual scope of the invention, which embraces all ways of practicing or implementing the teachings of the invention, is defined by the claims and their equivalents.

1. A computer-implemented method comprising:
receiving, within a program stored in a memory for execution by a processor, an event investigation inquiry;
retrieving, from a content database, a first set of research event information based on the event investigation inquiry and a second set of research event information based on the event investigation inquiry, the first set of research event information and the second set of research event information associated with a first research event and a second research event, respectively, the first research event and the second research event each being an action with a legal research system;
aggregating, the first set of research event information and the second set, of research event information into an aggregated set of research event information;
providing a result in an interactive format that allows for one or more views, wherein the result is associated with the aggregated set of research event information and each view is associated with a different representation of the aggregated set of research event information;
generating a signal associated with the result;
transmitting the signal to an access device.

2. The method of claim 1 wherein the first research event and the second research event is a first billing event and second billing event, respectively, associated with a the legal research system.

3. The method of claim 2 wherein the first billing event is a search event and the second billing event is a document view event.

4. The method of claim 1 wherein each of the first set of research event information and the second set of research event information includes at least one of: a timestamp; a date; a user name; a client identifier; a practice area; an office location; a research session type; a research session description; a reason code; an event description; a transaction detail; a research session length; a billable event indication; a subscription plan indication; a total cost value; a discount percentage; and a discounted cost value.

5. The method of claim 1 wherein the result is based on a set of administrative permissions.

6. The method of claim 1 further comprising:
retrieving, from a content database, an nth set of research event information based on the event investigation inquiry, the nth set of research event information associated with a nth research event, and
aggregating the first set of research event information, the second set of research event information and the nth set of research event information into an aggregated set of research event information.

7. The method of claim 1 farther comprising:
providing the result in a first view, the first view being a first representation of the aggregated set of research event information; and
providing, in response to an administrator initiation, the result in a second view, the second view being as second representation of the aggregated set of research event information.

8. The method of claim 7 wherein the first view is associated with a multiple-user representation and the second view is associated with a practice area representation.

9. The method of claim further comprising storing the aggregated set of research event information in an aggregating module.

10. The method of claim 9 further comprising:
providing the result in a first view, the first view being a first representation of the aggregated set of research event information; and
providing, in response to an administrator initiation, the result in a second view, the second view being a second representation of a stored aggregated set of research event information.

11. The method of claim 10 wherein the first view is associated with a multiple-user representation and the second view is associated with a user comparison representation.

12. An online research system:
a processor;
a memory coupled to the processor; and
a program stored in the memory for execution by the processor, the program configured to:
receive an event investigation inquiry;
retrieve a first set of research event information based on the event investigation inquiry and a second set of research event information based on the event investigation inquiry, the first set of research event information and the second set of research event information associated with a first research event and a second research event, respectively, the first research event and the second research event each being an action with a legal research system;
aggregate the first set of research event information and the second set of research event information into an aggregated set of research event information; and
provide a result in an interactive format that allows for one or more views, wherein the result is associated with the aggregated set of research event information and each view is associated with a different representation of the aggregated set of research event information.

13. The system of claim 12 wherein the first research event and the second research event is a first billing event and second billing event, respectively, associated with a the legal research system.

14. The system of claim 13 wherein the first billing event is a search event and the second billing event is a document view event.

15. The system of claim 12 wherein each of the first set of research event information and the second set of research event information includes at least one of: a timestamp; a date; a user name; a client identifier; a practice area; an office location; a research session type; a research session description; a reason code; an event description; a transaction detail; a research session length; a billable event indication; a subscription plan indication; a total cost value; a discount percentage; and a discounted cost value.

16. The system of claim 12 wherein the result is based on a set of administrative permissions.

17. The system of claim 12 the program further configured to:
retrieve an nth set of research event information based on the event investigation inquiry, the nth set of research event information associated with a nth research event; and
aggregate the first set of research event information, the second set of research event information and the nth set of research event information into an aggregated set of research event information.

18. The system of claim 12 the program further configured to:
provide the result in a first view, the first view being a first representation of the aggregated set of research event information; and
provide, in response to an administrator initiation, the result in a second view, the second view being a second representation of the aggregated set of research event information.

19. The system of claim 18 wherein the first view is associated with a multiple-user representation and the second view is associated with a practice area representation.

20. The system of claim 11 the program further configured to store the aggregated set of research event information in an aggregating module.

21. The system of claim 20 the program further configured to:
provide the result in a first view, the first view being a first representation of the aggregated set of research event information; and
provide, in response to an administrator initiation, the result in a second view, the second view being a second representation of a stored aggregated set of research event information.

22. The system of claim 21 wherein the first view is associated with a multiple-user representation and the second view is associated with a user comparison representation.
